(19) United States
(12) Patent Application Publication
(10) Pub. No.: US 2005/0124354 A1
(43) Pub. Date: Jun. 9, 2005

(54) Location estimation of wireless terminals using indoor radio frequency models

(76) Inventor: Gregory D. Durgin, Atlanta, GA (US)

Correspondence Address: DEMONT & BREYER, LLC, SUITE 250, 100 COMMONS WAY, HOLMDEL, NJ, 07733, US

(21) Appl. No.: 10/727,961

(22) Filed: Dec. 4, 2003

(51) Int. Cl. H04Q 7/20

(52) U.S. Cl. 455/456.1; 455/456.5

(57) ABSTRACT

A method of estimating the location of a wireless terminal that is within a structure is disclosed. In some embodiments, the method can be practiced without the addition of hardware to either the wireless terminal or to base stations of the telecommunications system. In the illustrative embodiment, an indoor radio frequency-signal propagation model is used to correct signal-strength predictions that are obtained from an outdoor radio frequency-signal propagation model. The indoor radio frequency model accounts for a “boundary” loss, which occurs as a radio signal first penetrates a structure (e.g., building, etc.), and/or, optionally, “interior” losses, which are experienced as the radio signal propagates further into the structure. Furthermore, in some embodiments, the model accounts for the effect of building orientation (e.g., the surface of the building, etc.) relative to outdoor transmitters (e.g., base stations, etc.).

### CROSS-REFERENCE TO RELATED APPLICATIONS

The following patents and patent applications are incorporated by reference:
(i) U.S. Pat. No. 6,269,246, issued 31 Jul. 2001;
(ii) U.S. patent application Ser. No. 09/532,418, filed 22 Mar. 2000;
(iii) U.S. patent application Ser. No. 10/128,128, filed 22 Apr. 2002;
(iv) U.S. patent application Ser. No. 10/299,398, filed 18 Nov. 2002; and
(v) U.S. patent application Ser. No. 10/357,645, filed 4 Feb. 2003.

### FIELD OF THE INVENTION

The present invention relates to telecommunications in general, and, more particularly, to a technique for estimating the location of a wireless terminal.

### BACKGROUND OF THE INVENTION

FIG. 1 depicts a map of geographic region 100, which is serviced by a wireless telecommunications system that provides wireless telecommunications service to wireless terminals (e.g., wireless terminals 102-1 and 102-2) within region 100.

A key element of the telecommunications system is wireless switching center 108. Wireless switching center 108 is typically connected to a plurality of base stations (e.g., base stations 104-A through 104-C), which are dispersed throughout region 100. As is well known in the prior art, wireless switching center 108 is responsible for establishing and maintaining calls between wireless terminals and, also, between a wireless terminal and a wireline terminal.

The salient advantage of wireless telecommunications over wireline telecommunications is the mobility that is afforded by being wireless. But the mobility is also a disadvantage when an interested party can not readily ascertain the user's location. For example, knowledge of a user's location can be important in emergency situations (e.g., a 9-1-1 call, etc.).

There are many techniques in the prior art for estimating the location of a wireless terminal.

In accordance with one technique, a radio navigation unit, (e.g., a Global Positioning System receiver, etc.) is incorporated into the wireless terminal. This technique works well outdoors, but it doesn't work well indoors because the signals that the radio navigation unit needs are attenuated by the building and, therefore, not strong enough to allow the radio navigation unit to determine its location.

In accordance with another technique, the signal strength of one or more base stations (e.g., 104-A, 104-B, 104-C) is measured at the wireless terminal (e.g., 102-1, 102-2) and then compared to a database that correlates reference signal-strength measurements to location. A wireless terminal at an unknown location measures the signal strength of the base stations around it. Pattern-matching algorithms then associate the signal-strength readings taken by the wireless terminal with the reference measurements in the database to estimate the location of the wireless terminal.

When the base stations and the wireless terminal are outdoors, this technique works well. The technique does not work well, however, when the transmitters are outdoors and the wireless terminal can be either indoors or outdoors. This is because the database that correlates reference signal-strength measurements to location is not valid for signal-strength measurements made indoors.

A need therefore exists for a method that is capable of estimating the location of a wireless terminal when it is indoors and when it is outdoors.

### SUMMARY OF THE INVENTION

Using the present invention, the position of a wireless terminal that is within a structure (e.g., office building, etc.) can be estimated without the addition of hardware to either the wireless terminal or to the base stations. Some embodiments of the present invention are, therefore, ideally suited for use with legacy systems.

The illustrative embodiment of the present invention is a method for determining the location of a wireless terminal through the pattern matching of signal-strength measurements to a database that correlates reference signal-strength measurements to location. The database uses a combination of an outdoor model of the radio frequency environment and an indoor model of the radio frequency environment. Some embodiments of the method are capable of:
determining the location of a wireless terminal regardless of whether it is indoors or outdoors;
determining whether a wireless terminal is indoors or outdoors; and
determining where in a building a wireless terminal is located.

In some embodiments of the present invention, the indoor radio frequency model accounts for a “boundary” loss, which occurs as a radio signal first penetrates a structure (e.g., building, etc.). In some embodiments of the present invention, the indoor radio frequency model accounts for “interior” losses, which are experienced as the radio signal propagates further into the structure through, for example, interior walls. In some embodiments of the present invention, the model accounts for both boundary and interior losses.

In some embodiments of the present invention, the indoor radio frequency model accounts for the orientation of the building's walls relative to the direction of signal propagation. In some embodiments of the present invention, this orientation dependence is applied as a correction to boundary loss to provide an orientation-dependent boundary loss. In some embodiments of the present invention, the orientation dependence is applied as a correction to the estimates of interior losses to provide orientation-dependent interior losses. And in some embodiments of the present invention, the model accounts for both orientation-dependent boundary losses and orientation-dependent interior losses.

The illustrative embodiment of the present invention comprises: accessing an outdoor radio frequency-signal propagation model, wherein the outdoor radio frequency-signal propagation model provides signal strength as a function of location; and modifying the signal strength provided by the outdoor radio frequency-signal propagation model with signal attenuation estimates that are provided by an indoor radio frequency-signal propagation model, wherein the indoor radio frequency-propagation model provides signal attenuation as a function of location within a building.

### BRIEF DESCRIPTION OF THE DRAWINGS

FIG. 1 depicts a map of a portion of a wireless telecommunications system in the prior art.

FIG. 2 depicts a map of the illustrative embodiment of the present invention.

FIG. 3 depicts a block diagram of the salient components of location system 210.

FIG. 4 depicts a broad overview of the salient operations performed by the illustrative embodiment in ascertaining the location of wireless terminal 202-1 in geographic region 200.

FIG. 5A depicts a graph that shows the decay in the signal strength of an electromagnetic signal as a function of distance from a transmitter and in an environment that is free of radio frequency obstacles.

FIG. 5B depicts a graph that shows the decay in the signal strength of an electromagnetic signal as a function of distance from a transmitter and within a building.

FIG. 6 depicts a flowchart of the salient operations performed in operation 402.

FIG. 7 depicts a raster map of geographic region 200.

FIG. 8 depicts building 206 located within the raster map of geographic region 200.

FIG. 9 depicts rasterized footprint 920 of building 206 in accordance with the illustrative embodiment of the present invention.

FIG. 10 depicts a layer structure of rasterized footprint 920 of building 206 in accordance with the illustrative embodiment of the present invention.

FIG. 11 depicts sub-operations for carrying out operation 610 to provide orientation-independent signal attenuation, in accordance with the illustrative embodiment.

FIG. 12 depicts orientation-independent signal attenuation as a function of position within rasterized footprint 920 of building 206 in accordance with the illustrative embodiment of the present invention.

FIG. 13 depicts sub-operations for carrying out operation 610 to provide orientation-dependent signal attenuation, in accordance with the illustrative embodiment.

FIG. 14 depicts surface vectors within rasterized footprint 920 of building 206, wherein the surface vectors are indicative of the surface normal direction of true edges of building 206.

FIG. 15 depicts a qualitative measure of the angle of incidence of a signal against a surface.

FIG. 16 depicts signal attenuation estimates from the indoor radio frequency-signal propagation model overlayed on a signal-strength map from an outdoor radio frequency-signal propagation model.

FIG. 17 depicts the signal-strength estimates from an outdoor radio frequency-signal propagation model corrected by signal-attenuation estimates from an indoor radio frequency-signal propagation model, in accordance with the illustrative embodiment of the present invention.

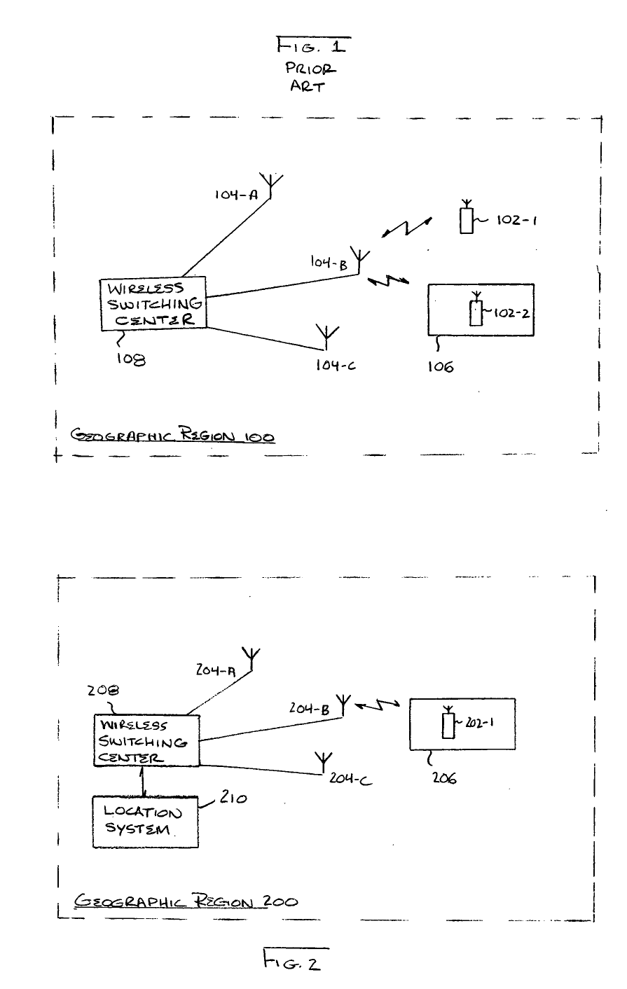

### DETAILED DESCRIPTION

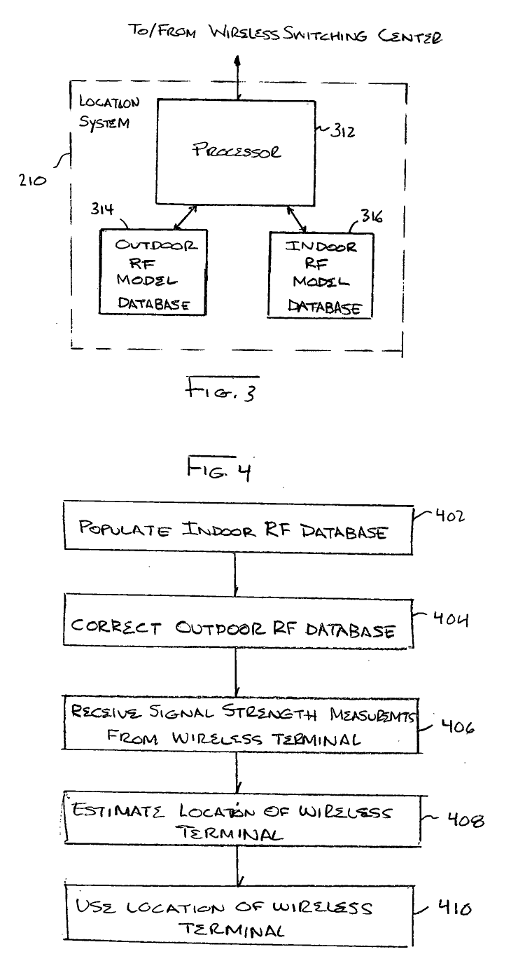

FIG. 2 depicts a schematic diagram of the salient features of the illustrative embodiment of the present invention. The illustrative embodiment comprises: wireless switching center 208, location system 210, base stations 204-A, 204-B, and 204-C, and wireless terminal 202-1, which are interrelated as shown. The illustrative embodiment provides wireless telecommunications service to most of geographic region 200, in well-known fashion, and is also capable of estimating the location of wireless terminal 202-1 within geographic region 200, even when the wireless terminal is within a structure, such as building 206.

The illustrative embodiment operates in accordance with the Global System for Mobile Communications (formerly known as the Groupe Speciale Mobile), which is ubiquitously known as “GSM.” But after reading this disclosure, it will be clear to those skilled in the art how to make and use embodiments of the present invention that operate in accordance with other protocols, such as the Universal Mobile Telephone System (“UMTS”), CDMA-2000, and IS-136 TDMA.

Wireless switching center 208 is a switching center, well-known to those skilled in the art in most respects, but different in that it is capable of communicating with location system 210 in the manner described below. After reading this disclosure, it will be clear to those skilled in the art how to make and use wireless switching center 208.

Base stations 204-A, 204-B, and 204-C are well-known to those skilled in the art and communicate with wireless switching center 210 through cables and other equipment (e.g., base station controllers, etc.) that are not shown in FIG. 2. Although the illustrative embodiment comprises three base stations, it will be clear to those skilled in the art how to make and use embodiments of the present invention that comprise any number of base stations.

Wireless terminal 202-1 is a standard GSM wireless terminal, as is currently manufactured and used throughout the world. Wireless terminal 202-1 is equipped, in well-known fashion, with the hardware and software necessary to measure and report to wireless switching center 208 the signal strength of the control and traffic channels from base stations 204-A, 204-B, and 204-C.

Location system 210 is a computer system that is capable of estimating the location of wireless terminal 202-1, as described in detail below. Although the illustrative embodiment depicts location system 210 as estimating the location of only one wireless terminal, it will be clear to those skilled in the art that location system 210 is capable of estimating the location of any number of wireless terminals serviced by wireless switching center 208.

In the illustrative embodiment, location system 210 is depicted in FIG. 2 as being distinct from wireless switching center 208. The illustrative embodiment is depicted this way principally for the purpose of highlighting the difference between the functions performed by wireless switching center 208 and the functions performed by location system 210. In some other embodiments, location system 210 can be integrated into wireless switching center 208, and it will be clear to those skilled in the art how to do so.

Wireless switching center 208, location system 210, and base stations 204-A, 204-B, and 204-C are depicted in FIG. 2 as being within geographic region 200 for pedagogical purposes, but this is not required. It will be clear to those skilled in the art how to make and use embodiments of the present invention in which some or all of these pieces of equipment are not within the region of location estimation.

FIG. 3 depicts a block diagram of the salient components of location system 210, which comprises: processor 312, outdoor radio frequency database 314 and indoor radio frequency database 316, which are interrelated as shown.

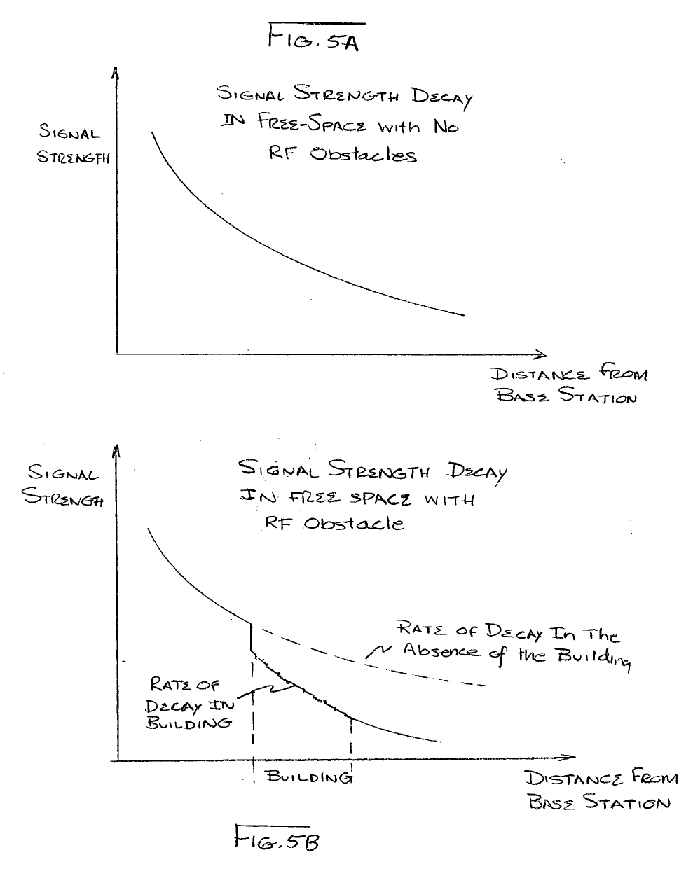

Processor 312 is a general-purpose processor as is well-known in the art that is capable of performing the operations described below and with respect to FIG. 4.

Outdoor radio frequency database 314 is a non-volatile memory that stores signal-strength values as developed from any suitable outdoor radio frequency-signal propagation model. As used herein, the term “outdoor radio frequency model” means a technique that provides signal strength as a function of position in “open” space; that is, not within a structure. This includes techniques that predict signal strength as a function of position in free space, or incorporate measured (empirical) data, or both. It is notable that some techniques, especially those that incorporate empirical data, will necessarily reflect the presence of radio frequency obstacles, such as trees and other structures. The term “outdoor radio frequency model” also includes these techniques (i.e., those that reflect the presence of radio frequency obstacles).

Outdoor radio frequency database 314 can be developed, for example, using the methods described in U.S. patent application Ser. No. 10/357,645. Ultimately, it is not important what specific method is used to populate outdoor radio frequency database 314. What is important is that outdoor radio frequency database 314 contains signal-strength data that:
is correlated (or capable of being correlated) to location within region 200; and
is in (or convertible to) a format that can be used with the information from the indoor radio frequency-signal propagation model, as described herein.

Indoor radio frequency database 316 is a non-volatile memory that stores signal attenuation values that are developed from an indoor radio frequency-signal propagation model, as described herein and with respect to FIG. 4. Outdoor radio frequency database 314 and indoor radio frequency database 316 are depicted as distinct entities primarily to highlight the distinction between the information that is contained in these databases. Those skilled in the art will be able to make and use such separate databases or, as desired, to make and use a single database that combines the information from the outdoor radio frequency model and the indoor radio frequency model.

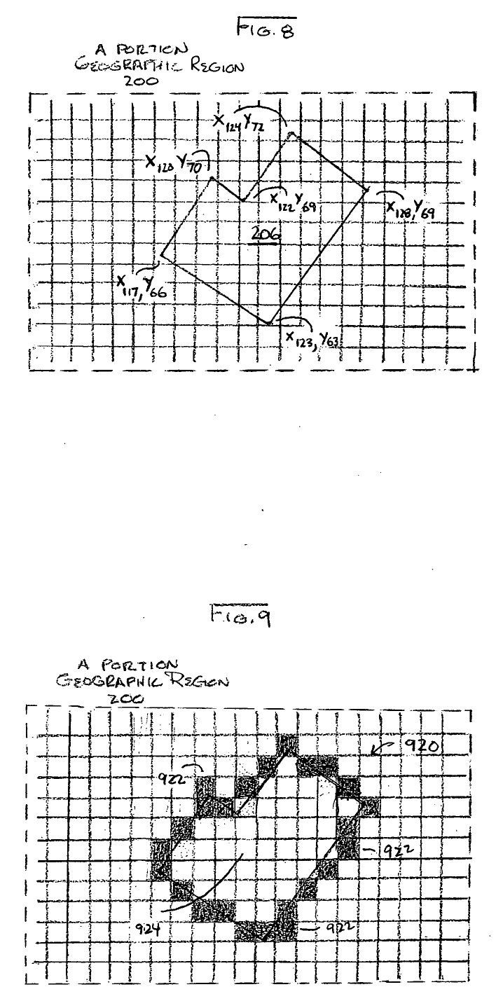

Overview—FIG. 4 depicts a broad overview of the salient operations performed by the illustrative embodiment in ascertaining the location of wireless terminal 202-1 in geographic region 200. This overview of operations assumes that outdoor radio frequency database 314 has been populated using a suitable outdoor radio frequency model. In summary, the tasks performed by the illustrative embodiment can be grouped for ease of understanding into five operations:
i. populating indoor radio frequency database 316 (operation 402);
ii. correcting outdoor radio frequency database 314 with attenuation values from indoor radio frequency database 316 (operation 404);
iii. receiving signal-strength measurements from wireless terminal 202-1 (operation 406);
iv. estimating the location of wireless terminal 202-1 (operation 408); and
v. using the location of wireless terminal 202-1 (operation 410).
   The details of each of these operations are briefly described below. Following this brief description, operation 402 (i.e., populating indoor radio frequency database 316) is described in further detail in conjunction with FIGS. 6 through 18.

In accordance with operation 402, indoor radio frequency database 316 is populated with data that associates location within a structure (e.g., building 206, etc.) with signal attenuation.

At operation 404, signal-strength values from outdoor radio frequency database 314 are “corrected” using signal-attenuation values that are contained in indoor radio frequency database 316. In some embodiments, this correction is performed by simply adding the signal-attenuation values (or subtracting them as a function of their sign) to the signal-strength values in outdoor radio frequency database 314.

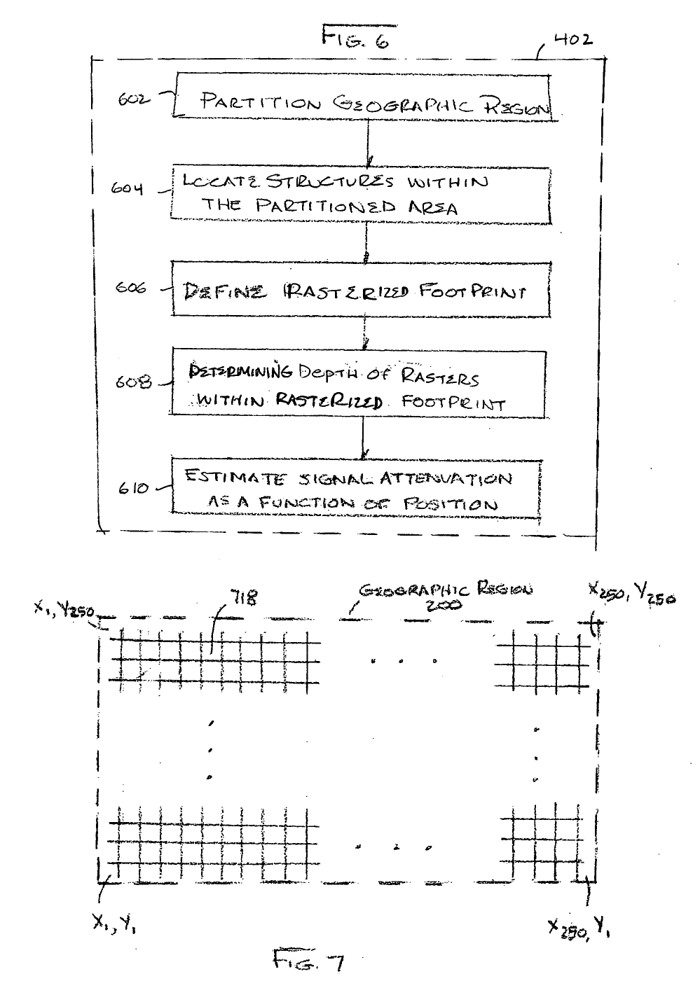

FIGS. 5A and 5b will aid in understanding the significance of operation 404. FIG. 5A depicts signal-strength decay in a free-space environment in the absence of radio frequency obstacles. In the illustration, signal strength decays continuously and exponentially as a function of distance from the transmitter. FIG. 5B depicts the effect of an obstacle, such as building 206, upon signal strength and signal-strength decay.

As depicted in FIG. 5B, the exterior of building 206 causes a step-down-change in signal strength. Furthermore, due to the presence of interior walls, etc., signal decay within building 206 does not mimic the decay observed in free space. Consequently, attempts to pattern match a signal that is measured by wireless terminal 202-1 (i.e., within a building) with uncorrected signal strength/location data from an outdoor radio frequency model will not produce an accurate estimate of wireless terminal's location.

In contrast, correcting the outdoor radio frequency model with signal-attenuation values from the indoor radio frequency model prior to pattern matching, in accordance with the present disclosure, yields a substantially more accurate estimate of signal strength vs. location within a structure such as building 206. As a consequence, a pattern matching operation between a measured signal and “corrected” signal strength/location data will typically yield a far more reliable estimate of the location of wireless terminal 202-1 when it is within a building.

At operation 406, location system 210 receives one or more signal-strength measurements from wireless terminal 202-1. Providing multiple signal-strength measurements, wherein each measurement provides a signal-strength reading for a different signal (transmitted from a different base station, etc.) ultimately results in a more accurate estimate of location. See, e.g., U.S. patent application Ser. No. 10/357,645.

In accordance with operation 408, the location of wireless terminal 202-1 is estimated. In some embodiments, the location of wireless terminal 202-1 is estimated by pattern matching the signal-strength measurements that are received from wireless terminal 202-1 with the corrected signal-strength measurements (from databases 414 and 416). Pattern matching can be performed using the methods described in U.S. patent application Ser. No. 10/357,645 (i.e., calculate signal-strength differentials, calculate the Euclidean norm, etc.), or using other suitable methods as are known or will otherwise occur to those skilled in the art in light of the present disclosure.

At operation 410, location system 210 transmits the location estimated in operation 408 to an entity (not shown) for use in an application (e.g., a 9-1-1 call, etc.).

Those skilled in the art will understand that the order in which at least some of operations 402-410 are performed, as described above, can be changed.

Operation 402, populating the indoor radio frequency database, is now described in detail.

FIG. 6 depicts a flowchart of the salient operations performed as part of operation 402.

At operation 602, geographic region 200 is partitioned into a plurality of tessallated locations or “rasters” 718. The size of raster 718 defines the highest resolution with which the illustrative embodiment can locate a wireless terminal. The resolution is advantageously set so that it is appropriate for the application. Since this operation supports the development of an indoor radio frequency-signal propagation model, the resolution is set to provide a scale that is useful in conjunction with location estimation within a building, such as an office building.

For example, in some embodiments, raster 718 has a size that is equal to the size of an average office, assumed to be about 4 meters×4 meters. As the size of raster 718 is reduced, the resolution of the embodiment increases, but the computational complexity of operation 402 increases.

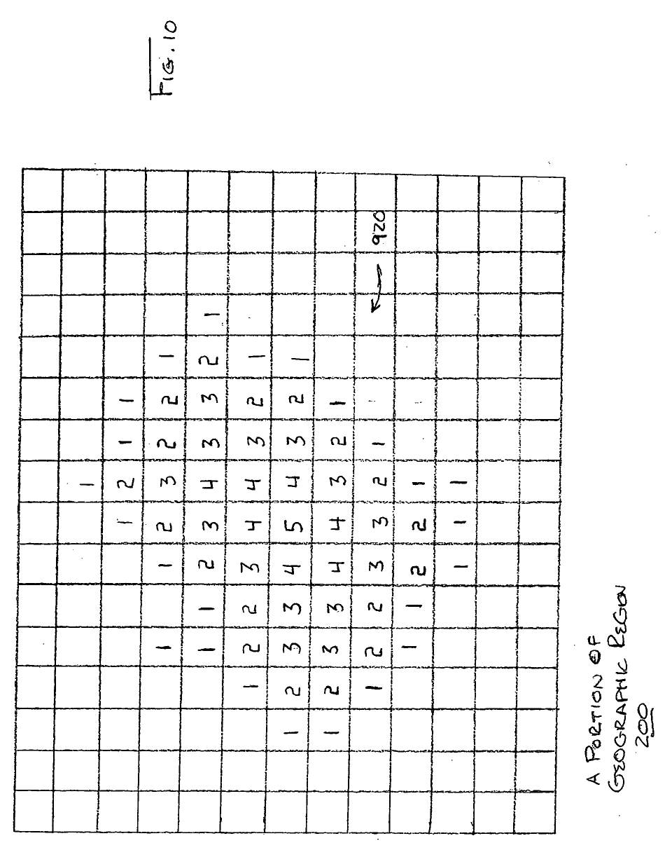

For the purposes of illustration, geographic region 200 is assumed to be square, with an area of 1 square kilometer. In accordance with the illustrative embodiment of the present invention, and as depicted in FIG. 7, geographic region 200 is partitioned into a grid of 62,500 square rasters 718 that are designated location x₁, y₁ through location x₂₅₀, y₂₅₀. The number of locations into which geographic location 200 is partitioned is arbitrary, subject to the considerations described above.

At operation 604, structures within geographic area 200, such as building 206, are identified. The edges of each structure must be properly oriented within geographic region 200, rasterized as described above. This can be done, for example, using survey information. FIG. 8 depicts a portion of geographic region 200, showing the edges of building 206 overlaying rasterized geographic area 200.

At operation 606, a rasterized footprint of building 206 is defined. In the illustrative embodiment, the rasterized footprint consists of two groups of rasters: those that define a perimeter or boundary of the footprint and those that define the interior of the footprint. The reason for segregating the rasters into two groups is that, in accordance with the illustrative embodiment, they are treated differently with respect to signal attenuation.

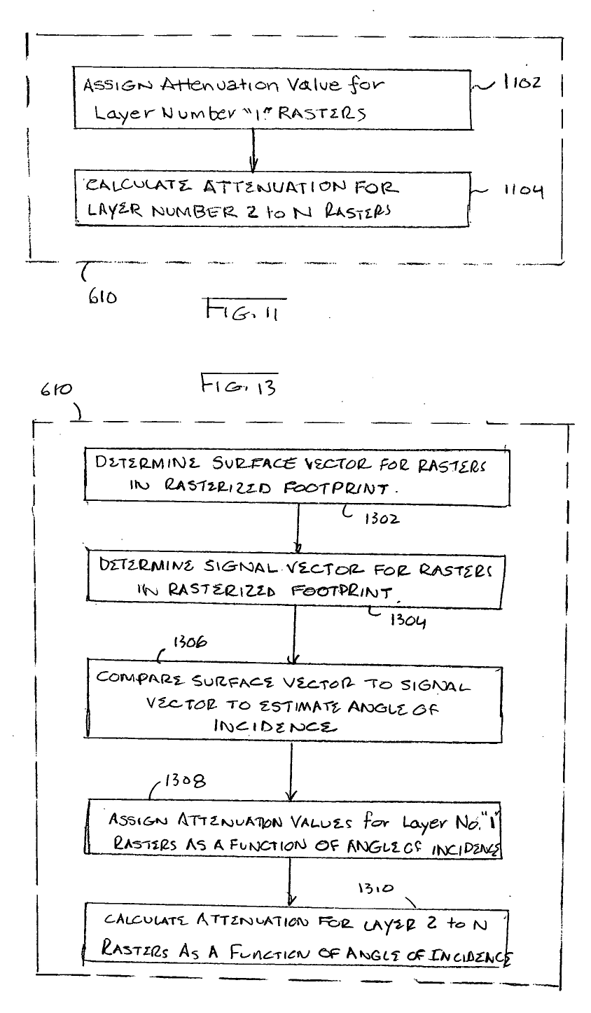

Referring to FIG. 9, in the illustrative embodiment, operation 606 consists of the sub-operations of identifying first group of rasters 922 that define the perimeter or boundary of rasterized footprint 920 and a second group of rasters 924 that define the interior of rasterized footprint 920. Rasters 924 are those rasters that fall within the perimeter or boundary defined by rasters 922.

A set of rules is developed for this categorizing operation. In the illustrative embodiment, to be categorized as belonging to first group of rasters 924, a raster must meet the following two conditions:
1. An edge of building 206 must pass through the raster; and
2. At least one side of the raster must be adjacent to an “outdoor” raster that is outside the perimeter of building 206.
   To be categorized as belonging to second group of rasters 924, a raster must meet the following two conditions:
1. It does not belong to first group of rasters 922; and
2. At least a portion of the raster falls within the region defined by the edges of building 206.
   If a raster is not part of first group of rasters 922 or second group of rasters 924, it is outside of rasterized footprint 920. It is understood that, in other embodiments, a different set of rules can be used for categorizing the rasters within rasterized footprint 920.

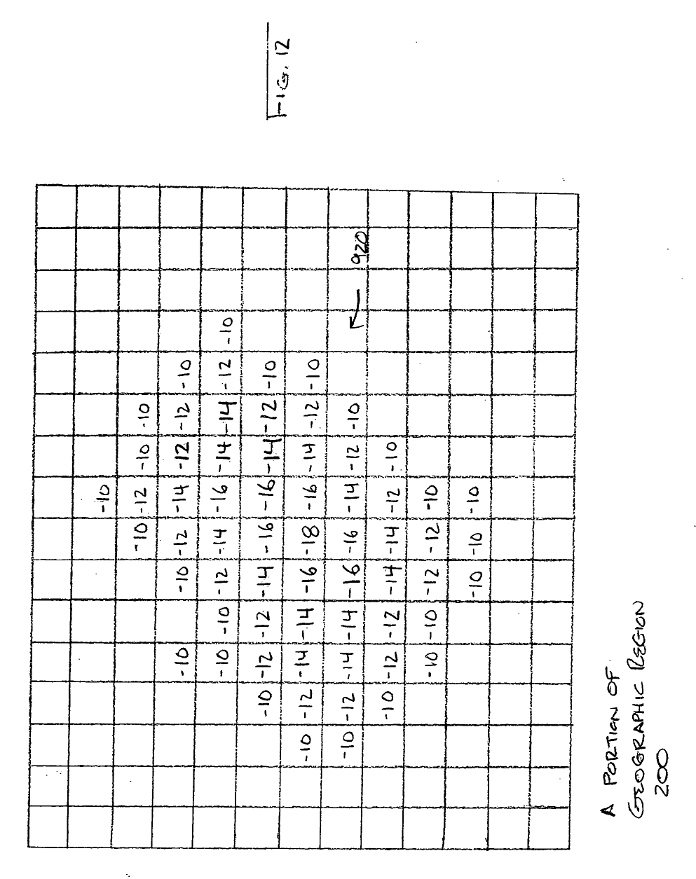

FIG. 10 depicts the rasterized footprint depicted in FIG. 8, but the edges of building 206 are not shown. In the illustrative embodiment, and in accordance with operation 608, once rasterized footprint 920 is defined, the depth of the rasters with rasterized footprint 920 is determined. In accordance with the illustrative embodiment, the depth of a raster is determined by assigning to it a “layer number.”

In the illustrative embodiment, rasters 922 (which define the perimeter of rasterized footprint 920) are each assigned a layer number of “1.” Rasters 924, which are within the interior of building 206, have a layer number of “2” or greater. In particular, each raster is assigned a layer number equal to one (1) plus the lowest layer number of the raster with which it shares a side. For example, rasters 924 that have a side that is adjacent to a raster 922 are assigned a layer number of “2.” Rasters 924 that have a side that is adjacent to rasters having a layer number of “2” but not “1” are assigned a layer number of “3,” and so forth.

Having defined the rasterized footprint (operation 606) and determined the depth of the rasters (operation 608), signal-attenuation estimates are developed in operation 610. The estimates developed in operation 610 provide signal attenuation as a function of position within building 206.

In some embodiments, signal-attenuation estimates are “orientation independent.” That is, the estimate does not consider the effect of the angle of incidence of the signal on a surface (e.g., wall, etc.) of a building. In some other embodiments, signal-attenuation estimates are “orientation dependent.” Methods for developing both types of signal-attenuation estimates are described below.

Orientation-Independent Signal Attenuation—FIG. 11 depicts the sub-operations of operation 610 for estimating orientation-independent signal attenuation. Attenuation of a radio frequency signal is assumed to occur at the boundary or perimeter of building 206 and also within building 206, as it penetrates successive interior walls. In accordance with sub-operation 1102, an attenuation value is assigned to each raster based on the raster's layer number. For example, the rasters with layer #1 (i.e., rasters 922) are assigned a loss or attenuation figure of 10 dB. This figure represents the amount of attenuation that occurs as a signal passes through the outer walls of building 206. See, Aguirre et al., “Radio Propagation into Buildings at 912, 1920, and 5990 MHz Using Microcells,” Proc. 3d. IEEE ICUPC, pp. 129-134 (October 1994); Davidson et al., “Measurement of Building Penetration into Medium Buildings at 900 and 1500 MHz,” IEEE Trans. On Vehicular Tech., v(46), pp. 161-167 (1997), both of which are incorporated by reference.

In an average-sized office (4 m×4 m) within the interior of a building, there is typically little if any attenuation of a propagating radio frequency signal at cellular (800-900 MHz) and PCS (1900 MHz) frequencies. As the signal penetrates a wall and leaves the office, a step change (drop) in signal strength occurs. An average signal attenuation of 2 dB per interior wall is used in the illustrative embodiment. Consequently, as a radio frequency signal penetrates each successive raster layer, an additional 2 dB of signal attenuation is incurred.

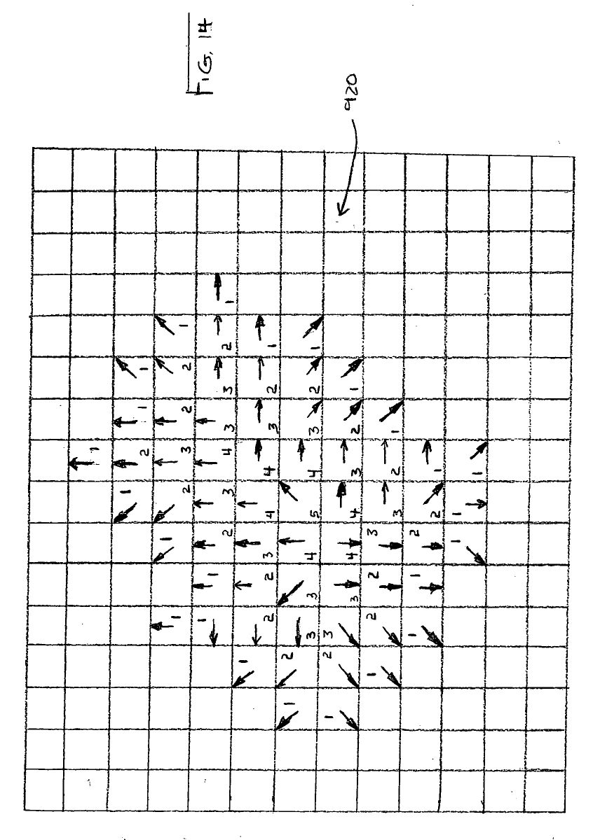

In accordance with sub-operation 1104, the attenuation at each raster having a layer number of 2 or more is calculated. In accordance with the illustrative embodiment, the attenuation at each layer is defined to be the mean value of the adjacent rasters from the previous layer plus 2 dB of signal attenuation for the present layer. FIG. 12 shows signal-attenuation values for rasterized footprint 920 of building 206. Each raster having a layer number of “1” is assigned an attenuation value of −10 dB. Each raster having a layer number of “2” has a signal attenuation of −12 dB (−12 dB=the mean value of the adjacent rasters from layer number “1” [−10 dB] plus −2 dB for layer number “2”). Each raster having a layer number of “3” has a signal attenuation of −14 dB (−14 dB=the mean value of the adjacent rasters from layer number “2” [−12 dB] plus −2 dB for layer number “3”), and so forth.

It will be appreciated that a given building material will have a characteristic amount of signal attenuation, and building-to-building variations in materials-of-construction will result in building-to-building variations in signal attenuation. For example, a signal will experience a greater amount of attenuation propagating through brick than through glass, and a greater amount of attenuation propagating through aluminum-backed insulation than paper-backed insulation. Consequently, in other embodiments, a higher or lower figure can suitably be used for orientation-independent “boundary” signal attenuation or “interior” signal attenuation, or both, as appropriate.

The signal-attenuation estimates that are developed from the operations described above are orientation independent. That is, the signal-attenuation estimates do not consider the orientation of features of the building (e.g., the walls of the building, etc.) with respect to the direction of signal propagation. Additional operations that are described below enable the illustrative method to provide orientation-dependent signal-attenuation estimates.

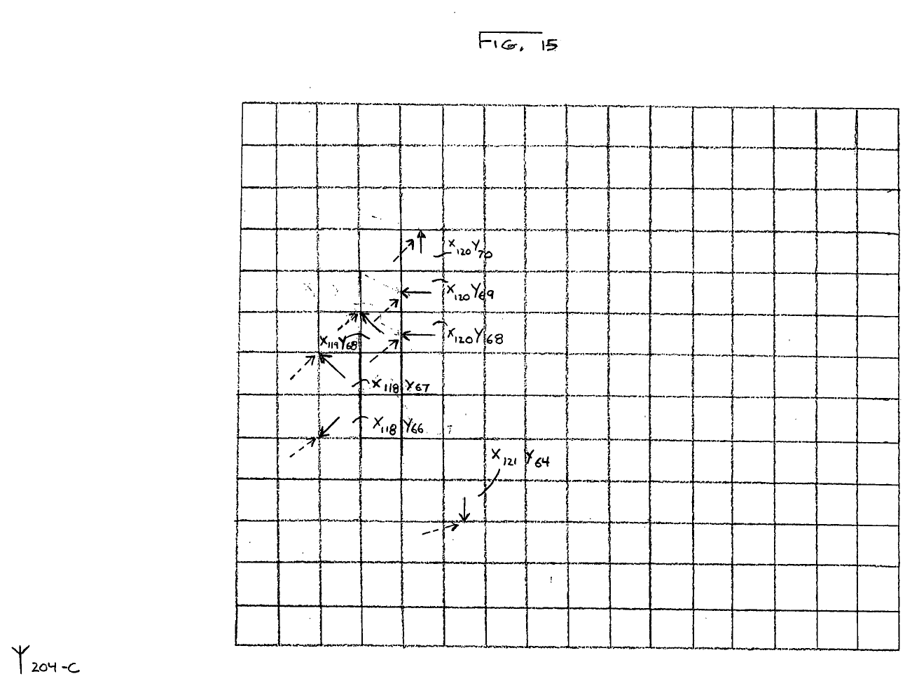

Orientation-Dependent Signal Attenuation It is well-known that the signal attenuation that occurs as a radio wave penetrates a wall of a building varies as a function of the angle of incidence of the signal with respect to the wall. Consequently, an improved estimate of signal attenuation (operation 610) can be obtained by estimating the angle of incidence of the signal with respect to the exterior wall of building 206. Once the angle of incidence is estimated for rasters in rasterized footprint 920, the rasters are assigned a signal-attenuation value that is a function of the angle of incidence. FIG. 13 depicts sub-operations of operation 610 for estimating orientation-dependent signal attenuation.

As is apparent from FIG. 9, rasterized footprint 920 often does not represent the exterior walls of building 206 well. For example, when a building's exterior walls are not parallel with the sides of the rasters, the sides of the rasters do not accurately represent the position or angular orientation of the building's exterior walls.

As a consequence, some embodiments of operation 610 include sub-operation 1302, wherein each raster in footprint 902 is assigned a “surface” vector. For the purposes of this specification, the “surface vector” of a raster is defined as a unit vector that is normal to the building's exterior wall at the point on the exterior wall that is closest to the raster.

In accordance with the illustrative embodiment, and as depicted in FIG. 14, each raster at layer 1 (i.e., rasters 922) is assigned a surface vector that points toward one of eight directions. The direction selected is an estimate of the surface-normal direction of the building's true boundary at the raster. Assuming that for rasterized region 200 “North” is “up,” then, moving clockwise around a raster, the eight directions are “North,” “Northeast,” “East,” “Southeast,” “South,” “Southwest,” “West,” and “Northwest.”

In accordance with the illustrative embodiment, a set of rules is adopted to perform the surface-vector calculation. It will be clear to those skilled in the art how to make and use alternative embodiments of the present invention that perform the surface-vector calculation using other rules.

In accordance with the illustrative embodiment, the following rules apply to perform the surface-vector calculation. For each raster in layer 1, the surface vector is based on the number and position of the layer 1 rasters that are adjacent to a side of the raster in question and is equal to the direction that is the mean of the adjacent layer 1 rasters. For example, consider a layer 1 raster that is bounded by three layer 1 rasters: one on its left (West) side, one on its top (North) side, and one on its right (East) side. The raster will be assigned a surface vector that points North because North is the mean of West, North, and East.

As another example, consider a layer 1 raster that is bounded on its North side and East side by other layer 1 rasters. The raster in question will be assigned a surface vector that points “Northeast,” which is the mean direction of North and East.

For each raster in a layer n, wherein n is a positive integer greater than 1, only those rasters in layer n-1 that are adjacent to one of the four sides of the raster in question are considered for the calculation. In particular, the surface vector assigned to the layer n raster in question is equal to the mean of surface vectors in the layer n-1 rasters that are adjacent to one of the four sides of the layer n raster in question.

For example, if a layer 2 raster is bounded at its North and East sides by layer 1 rasters whose surface vectors point “North,” then the layer 2 raster in question is assigned a surface vector that points “North.” This is in contrast from a layer 1 raster, which, in the situation just described, would be assigned a surface vector that points “Northeast.”

In the case of a calculated surface vector whose direction is exactly between an orthogonal compass direction (i.e., North, East, South, West) and a hybrid compass direction (i.e., Northeast, Southeast, Southwest, Northwest), the assigned surface vector is rounded to the nearest orthogonal compass direction.

To estimate the angle of incidence of a signal on building 206, the position of a transmitter (e.g., base station, etc.) must be known. In accordance with operation 1304, a signal vector is assigned to each raster in rasterized footprint 920. For the purposes of this specification, the term “signal vector” is defined as a vector that provides an estimate of the direction of a transmitter from a raster. Each signal vector is given one of the four orthogonal or four hybrid compass headings. When the building of interest is far from the transmitter of interest, all of the signal vectors in the building are parallel.

The angular difference between the signal vector in a raster and the surface vector in that raster is an estimate of the angle of incidence of the signal to the surface of the building, and provides, therefore, a guide to the orientation-dependent signal loss expected at that raster.

For the purposes of the illustrative embodiment, the angular difference between the surface vector and the signal vector is assigned to one of five categories.

TABLE 1
Signal Attenuation as a Function of Angular Difference
Between Surface Vector and Signal Vector

| | Angular | |
|---|---|---|
| | Difference | |
| | Between Surface | Relative Signal |
| | Vector and Signal | Attenuation |
| | Vector (in | Due To Angle |
| Category | absolute degrees) | of Incidence |
| Near-Normal | 0° to 22.5° | 0.8 |
| Oblique | 22.5° to 67.5° | 1.0 |
| Grazing | 67.5° to 112.5° | 1.7 |
| Oblique Back- | 112.5° to 157.5° | 2.0 |
| Scatter | | |
| Near-Normal | 157.5° to 180° | 2.3 |
| Back-Scatter | | |

Assuming that the average figure of 10 dB for boundary loss that was previously disclosed represents the loss at oblique incidence, the signal attenuation at the boundary for the various modes are, respectively:
8 dB<10 dB<17 dB<20 dB<23 dB
Assuming that the average figure of 2 dB for interior losses per layer that was previously disclosed represents the loss at oblique incidence, the signal attenuation, per layer, in the interior of the building for the various modes is, respectively:
1.6 dB<2.0 dB<3.4 dB<4 dB<4.6 dB

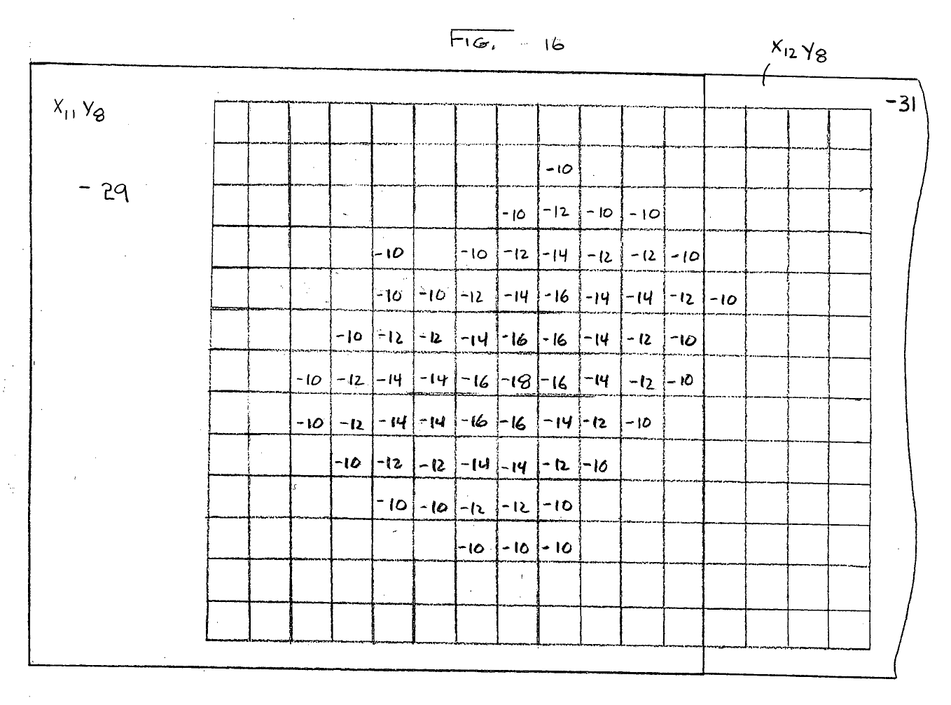

After the surface vector and the signal vector for the rasters of interest (e.g., rasters 922, rasters 924, or both groups) are defined, the angle of incidence is determined. FIG. 15 depicts the comparison operation, wherein both the surface vector (“solid” arrow) and the signal vector (“dashed” arrow) are depicted for several of the rasters that compose raster footprint 920. Raster x₁₂₁y₆₄ has a surface vector that points “South” and a signal vector that points “Northeast.” Reference to FIG. 15 indicates that this is illustrative of “grazing incidence.” Raster x₁₁₈y₆₆ has a surface vector that points “Southwest” and a signal vector that points “Northeast.” FIG. 15 shows this to be illustrative of “near-normal incidence.” Raster x₁₁₈y₆₇ has a surface vector that points “Northwest” and a signal vector that points “Northeast.” This is illustrative of “grazing incidence,” as defined in FIG. 15. Raster x₁₁₉y₆₈ has a surface vector that points “Northwest” and a signal vector that points “Northeast.” According to FIG. 15, this is illustrative of “grazing incidence.” Raster x₁₂₀y₆₉ has a surface vector that points “West” and a signal vector that points “Northeast.” According to FIG. 15, this is illustrative of “oblique incidence.” Raster x₁₂₀y₇₀ has a surface vector that points “North” and a signal vector that points “Northeast.” This is illustrative of “oblique back-scatter.”

The rasters described above have a layer number that is equal to 1; that is, they define the perimeter of raster footprint 920. The same comparison operation can be repeated for interior rasters, such as raster x₁₂₀y₆₈, which has a surface vector that points “West” and a signal vector that points “Northeast.” This is illustrative of “oblique incidence.”

FIG. 15 depicts the surface vector and signal vector for several rasters that compose rasterized footprint 920.

As per sub-operation 1308, once the angle of incidence is estimated for each raster defining the perimeter of rasterized footprint 920, a signal-attenuation value can be assigned to the raster, as described above. For rasters having a layer number of “1,” the attenuation figures can be taken from the numbers provided above. Table 2 below summarizes the results of the comparison operation, etc., for the rasters listed above.

TABLE 2
Estimation of Angle of Incidence of Radio Frequency Signal

| | LAYER | | SIGNAL |
|---|---|---|---|
| RASTER | NUMBER | INCIDENCE | ATTENUATION |
| x₁₂₁y₆₄ | 1 | Grazing | 17 dB |
| x₁₁₈y₆₆ | 1 | Near-Normal | 8 dB |
| x₁₁₈y₆₇ | 1 | Grazing | 17 dB |
| x₁₁₉y₆₈ | 1 | Grazing | 17 dB |
| x₁₂₀y₆₉ | 1 | Oblique | 10 dB |
| x₁₂₀y₇₀ | 1 | Oblique Back-scatter | 23 dB |
| x₁₂₀y₆₈ | 2 | Oblique | 15.5 dB |

In accordance with sub-operation 1310, if orientation-dependent interior signal loss is desired, it is calculated as previously described, with the exception that rather than simply adding 2 dB, etc., of loss per layer, an orientation-dependent interior signal loss is applied. For example, raster x₁₂₀y₆₈ is bounded by two rasters having a layer number of “1:” raster x₁₁₉y₆₈ and raster x₁₂₀y₆₉. The signal attenuation at raster x₁₂₀y₆₈ is the mean of the signal attenuation at rasters x₁₁₉y₆₈ and x₁₂₀y₆₉, which is (17 dB+10 dB)/2, plus the attenuation at layer “2” raster x₁₂₀y₆₈, which is 2 dB (oblique incidence). The signal attenuation at raster x₁₂₀y₆₈ is, therefore, 13.5+2=15.5 dB.

It will be understood that in various embodiments, signal-attenuation estimates can be orientation-independent, orientation-dependent, or a combination thereof. For example, in some embodiments, signal-attenuation estimates for the perimeter of building 206 can be orientation dependent, while interior losses can be orientation independent, or vice-versa.

Referring again to FIG. 4, once indoor radio frequency database 316 has been populated (e.g., with signal-attenuation values, etc.) in accordance with operation 402, signal-strength estimates from the outdoor radio frequency database are corrected, as per operation 404.

To perform operation 404, the data from the indoor radio frequency database and the outdoor radio frequency database must be geographically consistent. In other words, the signal-attenuation values from indoor radio frequency database 316 must be overlaid onto the signal-strength estimates from outdoor radio frequency database 314 in a geographically-correct position. This alignment can be performed using longitude and latitude readings of the buildings and properly placing them into a map generated by the outdoor radio frequency database. Furthermore, to the extent that the signal-attenuation values in the indoor radio frequency database are orientation dependent, then the data in both indoor radio frequency database 316 and outdoor radio frequency database 314 must be for the same transmitter(s).

Typically, the partitioning (rastering) process used for generating outdoor radio frequency database 314 will use larger partitions (i.e., rasters) than indoor radio frequency database 316. As a consequence, in some embodiments, the rasterized footprint of a structure, such as building 206, is likely to lie within a single raster of outdoor radio frequency database 314. In such a case, then the signal-attenuation values from the indoor radio frequency database are simply subtracted from (or added to) a single signal-strength reading. To the extent that the rasterized footprint of a building covers a plurality of rasters of the outdoor radio frequency database, then the attenuation values from indoor radio frequency database 316 are subtracted from (or added to) one of several signal-strength readings, as is appropriate for its location.

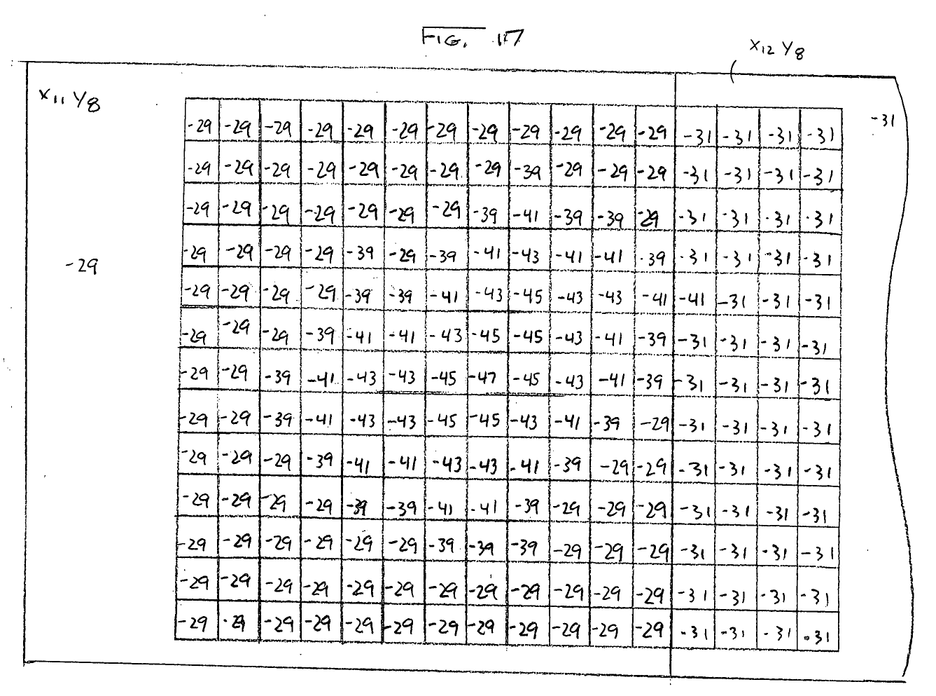

FIG. 16 depicts signal-attenuation estimates for building 206 from indoor radio frequency database 316 over laid, at the appropriate location, onto signal-strength readings from outdoor radio-frequency database 314. As depicted in FIG. 16, with the exception of one raster, all rasters from rasterized footprint 920 lie within raster x₁₁y₈ of outdoor radio frequency database 314. The signal strength in raster x₁₁y₈ is −29 dB. The one remaining raster from rasterized footprint 920 falls within raster x₁₂y₈ of outdoor radio frequency database 314. The signal strength in raster x₁₂y₈ is −31 dB.

FIG. 17 depicts corrected signal strength readings, wherein the signal-strength readings from outdoor radio frequency database 314 are corrected by the signal attenuation readings from indoor radio frequency database 316.

With corrected data from the outdoor radio frequency database and with signal-strength measurements from the wireless terminal (operation 406) of unknown location, the location of the wireless terminal can be estimated.

The location of the wireless terminal can be estimated by pattern matching the signal-strength measurements obtained by the wireless terminal at a location against the corrected signal-strength readings. This process is described in detail in co-pending application U.S. patent application Ser. No. 10/357,645. It is understood that the signal-strength readings obtained by the wireless terminal must be from the same transmitter(s) that are used to develop outdoor radio frequency database 314 and indoor radio frequency database 316 (when orientation-dependent attenuation figures are used).

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

1. A method for estimating a location of a wireless terminal, said method comprising:
defining a rasterized footprint of a building, wherein said rasterized footprint comprises a plurality of rasters, and wherein said rasterized footprint has a boundary and an interior; and
estimating signal attenuation due to said building, wherein the estimate of signal attenuation is based on signal losses at a first group of said rasters, wherein said rasters in said first group define said boundary of said rasterized footprint.

2. The method of claim 1 wherein estimating signal attenuation further comprises basing the estimate of signal attenuation on signal losses at a second group of said rasters, wherein said rasters in said second group define said interior of said rasterized footprint.

3. The method of claim 2 further comprising determining a depth of said raster within said rasterized footprint,
wherein said depth of said raster is defined by a layer number, L;
wherein rasters defining said boundary have a layer number, L=1;
wherein rasters defining said interior have a layer number L=2 to n, wherein n is a positive integer; and
wherein signal attenuation at layer L=m, wherein m≧2, is based on the signal losses at layers L=1 through m−1.

4. The method of claim 1 wherein estimating signal attenuation further comprises accounting for an effect of building orientation with respect to a direction of signal propagation on signal losses at said first group of rasters.

5. The method of claim 2 wherein estimating signal attenuation further comprises accounting for an effect of building orientation with respect to a direction of signal propagation on signal losses at said second group of rasters.

6. The method of claim 4 wherein estimating signal attenuation further comprises accounting for an effect of building orientation with respect to a direction. of signal propagation on signal losses at said second group of rasters.

7. The method of claim 2 further comprising developing a map from the estimate of signal attenuation, wherein said map associates location within said building with an indicator of signal attenuation.

8. The method of claim 7 further comprising using the signal-attenuation information from said map to adjust signal-strength estimates that are obtained from an outdoor radio frequency database.

9. The method of claim 8 further comprising:
receiving a first signal-strength measurement for a first signal at said wireless terminal; and
estimating the location of said wireless terminal by pattern matching a function of said first signal-strength measurement against the adjusted signal-strength estimates.

10. A method for estimating a location of a wireless terminal, said method comprising:
defining a rasterized footprint of a building, wherein said rasterized footprint comprises a plurality of rasters, and wherein said rasterized footprint has a boundary and an interior, and further wherein rasters at said boundary of said rasterized footprint define a first group of rasters; and
estimating signal attenuation due to said building, wherein the estimate of signal attenuation is based on signal losses in a second group of said rasters, wherein said rasters in said second group are in said interior of said rasterized footprint.

11. The method of 10 further comprising determining a depth of said raster within said interior of said rasterized footprint,
wherein said depth of said raster is defined by a layer number, L;
wherein rasters defining said boundary have a layer number, L=1;
wherein rasters within said interior have a layer number L=2 to n, wherein n is a positive integer; and
wherein signal attenuation experienced at layer L=m, wherein m≧2, is based on the signal losses at layers L=1 through m−1.

12. The method of claim 10 wherein estimating signal attenuation further comprises accounting for an effect of building orientation with respect to a direction of signal propagation on signal losses at said second group of rasters.

13. The method of claim 10 further comprising adjusting signal-strength estimates obtained from an outdoor radio frequency database using the estimates of signal attenuation within said building.

14. The method of claim 13 further comprising receiving a first signal-strength measurement for a first signal at said wireless terminal; and
estimating the location of said wireless terminal by pattern matching a function of said first signal-strength measurement against the adjusted signal-strength estimates.

15. A method for estimating a location of a wireless terminal, said method comprising:
defining a rasterized footprint of a building, wherein said rasterized footprint comprises a plurality of rasters, and wherein said rasterized footprint has a boundary, an interior, and an exterior; and
estimating signal attenuation due to said building, wherein the estimated signal attenuation is a function of an angle of incidence of a signal with respect to one or more physical features of said building, wherein said signal is transmitted from a transmitter.

16. The method of claim 15 wherein estimating signal attenuation further comprises estimating a surface vector of a raster at said boundary.

17. The method of claim 16 wherein said surface vector is estimated using at least one raster at said exterior of said raster footprint that is adjacent to said raster at said boundary.

18. The method of claim 16 wherein estimating signal attenuation further comprises estimating a signal vector of said raster at said boundary, wherein said signal vector points toward said transmitter from said raster.

19. The method of claim 18 wherein estimating signal attenuation further comprises determining a difference between said surface vector and said signal vector.

20. The method of claim 15 further comprising assigning an attenuation value to a raster at said boundary as a function of said angle of incidence of said signal.

21. A method for estimating a location of a wireless terminal, said method comprising:
defining a rasterized footprint of a building, wherein said rasterized footprint comprises a plurality of rasters, and wherein said rasterized footprint has a boundary, an interior, and an exterior; and
estimating signal attenuation due to said building, wherein the estimated signal attenuation is a function of signal losses that occur within said building, which losses are a function an angle of incidence of a signal with respect to said building, wherein said signal is transmitted from a transmitter.

22. The method of claim 21 wherein estimating signal attenuation further comprises estimating a surface vector of a raster within an interior of said raster footprint.

23. The method of claim 22 further comprising determining a depth of said raster within said interior;
wherein said depth of said raster is defined by a layer number, L;
wherein rasters within said interior have a layer number L=2 to n, wherein n is a positive integer; and
wherein said surface vector of a raster at layer L=m, where 2≦m≧n, is estimated using at least one raster at layer L=m−1 that is adjacent to said raster at layer L=m.

24. The method of claim 22 wherein estimating signal attenuation further comprises estimating a signal vector of said raster within said interior, wherein said signal vector points toward said transmitter from said raster.

25. The method of claim 24 wherein estimating signal attenuation further comprises determining a difference between said surface vector and said signal vector.

26. The method of claim 21 further comprising assigning an attenuation value to a raster at said boundary as a function of said angle of incidence of said signal.

27. A method for estimating a location of a wireless terminal, said method comprising:
accessing an outdoor radio frequency database, wherein said outdoor radio frequency database provides signal strength as a function of location; and
modifying said signal strength, as provided by said outdoor radio frequency database, with signal-attenuation values from an indoor radio frequency database, wherein said indoor radio frequency database provides signal attenuation as a function of location within a structure.

28. The method of claim 27 further comprising:
receiving a first signal-strength measurement for a first signal at said wireless terminal; and
estimating the location of said wireless terminal by pattern matching a function of said first signal-strength measurement against signal-strength data from said outdoor radio frequency database, as modified by said indoor radio frequency database.

29. The method of claim 27 wherein said signal-attenuation values from said indoor radio frequency database are orientation-independent.

30. The method of claim 27 wherein said signal-attenuation values from said indoor radio frequency database are orientation-dependent.
